(19) United States
(12) Patent Application Publication
(10) Pub. No.: US 2012/0186925 A1
(43) Pub. Date: Jul. 26, 2012

(54) METHODS AND DEVICES FOR MITIGATING VIBRATION IN A DRIVE CARRIER

(75) Inventor: Peter R. Janik, Shakopee, MN (US)

(73) Assignee: SEAGATE TECHNOLOGY LLC, Shakopee, MN (US)

(21) Appl. No.: 13/009,968

(22) Filed: Jan. 20, 2011

(51) Int. Cl. F16F 7/10; B23P 17/04

(52) U.S. Cl. 188/378; 29/428

(57) ABSTRACT

In certain embodiments, an apparatus includes a drive carrier that has a damping material positioned between an inertia weight and the drive carrier. In certain embodiments, a method includes attaching a damping material to a drive carrier and attaching a mass to the damping material.

### SUMMARY

Various embodiments of the present invention are generally directed to an apparatus and methods for reducing vibration of a drive while in a drive carrier.

In certain embodiments, an apparatus includes a drive carrier that has a damping material positioned between an inertia weight and the drive carrier. In certain embodiments, a method includes attaching a damping material to a drive carrier and attaching a mass to the damping material.

### BRIEF DESCRIPTION OF THE DRAWINGS

FIG. 1 provides an isometric, exploded view of an exemplary drive carrier, in accordance with various embodiments of the present disclosure.

FIG. 2 provides a cross-sectional view of the exemplary drive carrier of FIG. 1.

FIG. 3 provides an isometric, exploded view of an exemplary drive carrier, in accordance with various embodiments of the present disclosure.

FIG. 4 provides an isometric view of an exemplary drive carrier, in accordance with various embodiments of the present disclosure.

FIG. 5 provides a cross-sectional view of the exemplary drive carrier of FIG. 4.

FIG. 6 provides an isometric view of an exemplary drive carrier, in accordance with various embodiments of the present disclosure.

FIG. 7 provides a cross-sectional view of the exemplary drive carrier of FIG. 6.

### DETAILED DESCRIPTION

Drive carriers retain storage drives so that the carrier and drive can be inserted, for example, into a housing or bay in a storage rack for testing or operating the drive. Storage racks may be placed near other storage racks and may include, among other devices, cooling fans and multiple drives—each of which subject the storage rack and drives to vibrations, which can cause errors and/or performance throughput loss in the drives. Attempts to reduce vibration in drive carriers have not adequately addressed rotary and linear vibration mitigation. Moreover, previous techniques lacked the design flexibility and effectiveness associated with damping vibration by isolating inertia weights from drive carriers.

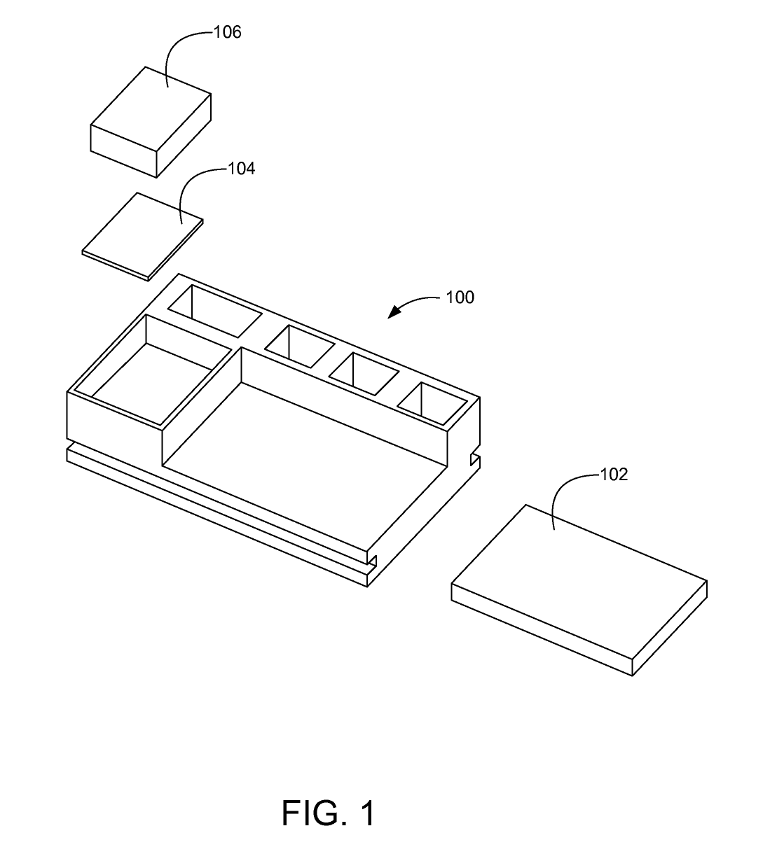

FIG. 1 is an exploded view of a drive carrier 100, drive 102, damping material 104, and inertia weight 106. When assembled, the drive carrier 100 retains the drive 102 so that the drive 102 and carrier 100 can be inserted storage rack housings or bays. The drive 102 may include single or multiple suitable storage devices, including but not limited to a solid state drive, a hard disc drive, or a combination of both.

The carrier 100 includes a damping material 104 and an inertia weight 106. The damping material 104 may be positioned between the carrier 100 and the inertia weight 106. For example, the damping material 104 may be attached to the carrier 100, and the inertia weight 106 may be attached to the damping material 104. The damping material 104 and inertia weight 106 may be attached to the carrier 100 by any suitable means, including adhering or fastening the elements together.

The damping material 104 is positioned on the carrier 100 such that, when the carrier 100 is subjected to rotational and linear vibration, the damping material 104 is placed in shear between the inertia weight 106 and another surface—for example, the carrier 100 or another inertia weight. When the damping material 104 is subjected to shear movement, rotational and linear vibration is mitigated because the damping material 104 isolates the inertia weight 106 and converts the vibrational energy to thermal energy. The inertia weight 106 does not directly contact the carrier 100 and is therefore isolated from the carrier 100. Mitigating the vibrational energy may reduce the noise created by the drive 102, may reduce the energy required to operate the drive 102, and may reduce the number of storage drive errors thereby increasing throughput performance. In addition, the damper/mass combination may be modeled as a spring-mass-damper system, for example, by modifying a contact area between the damping material 104 and the inertia weight 106, which changes the effective stiffness of the damper/mass system.

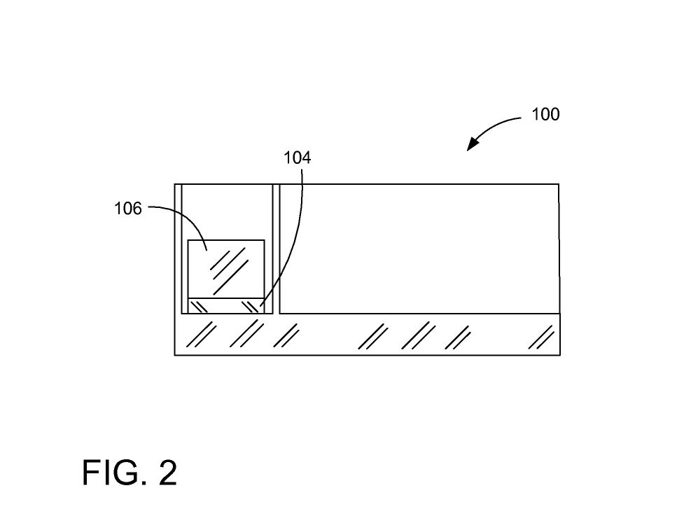

In some exemplary embodiments, the position of the damper/mass combination 104 and 106 can be optimized for different applications. For example, the damping material 104 and inertia weight 106 may be placed at a corner of the drive where rotational vibration may be the greatest. Alternatively, the damper/mass combination 104 and 106 may be placed such that the center of mass of the carrier 100 is modified. The damper/mass combination 104 and 106 may be enclosed within the carrier 100 and therefore not visible. FIG. 2 is a cross-sectional view of the carrier 100, damping material 104, and inertia weight 106.

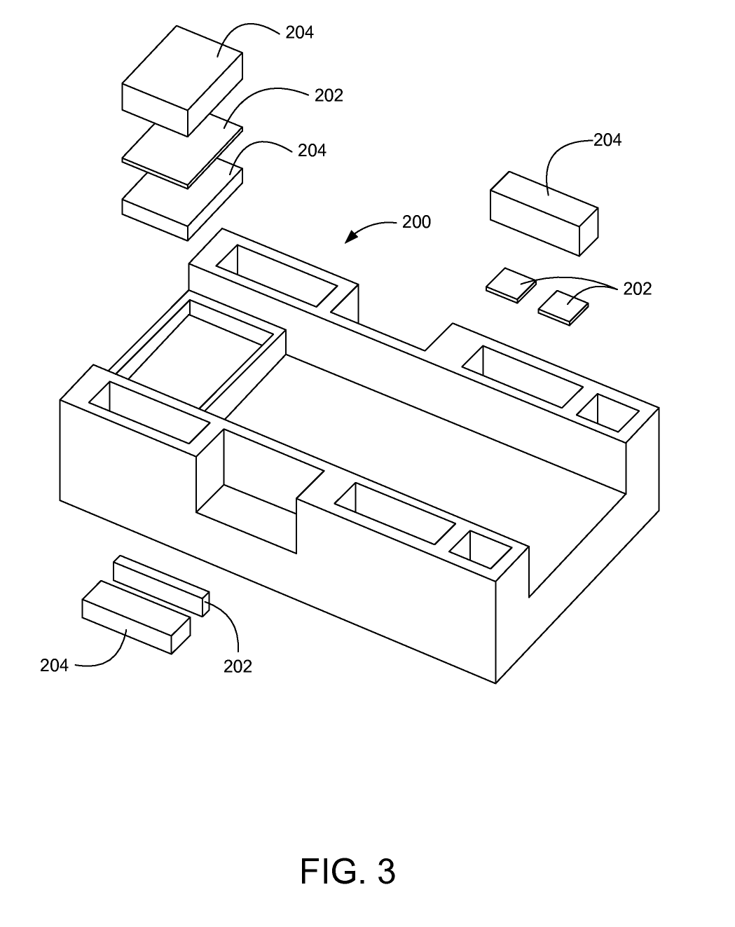

As shown in FIG. 3, a drive carrier 200 includes a plurality of damping material sections 202 (hereinafter referred to as damping material 202) and a plurality of inertia weights 204 (hereinafter referred to as inertia weights 204). The damping material 202 may be positioned between the inertia weights 204, one of which can be attached to the drive carrier 200. The damping material 202 and the inertia weights 204 may be positioned on the top, bottom, and/or sides of the drive carrier 200. Multiple sections of damping material 202 may be positioned between the inertia weights 204 and drive carrier 200. The damping material 202 is positioned such that, when subjected to vibration, the damping material 202 is placed in shear, thereby mitigating the vibration.

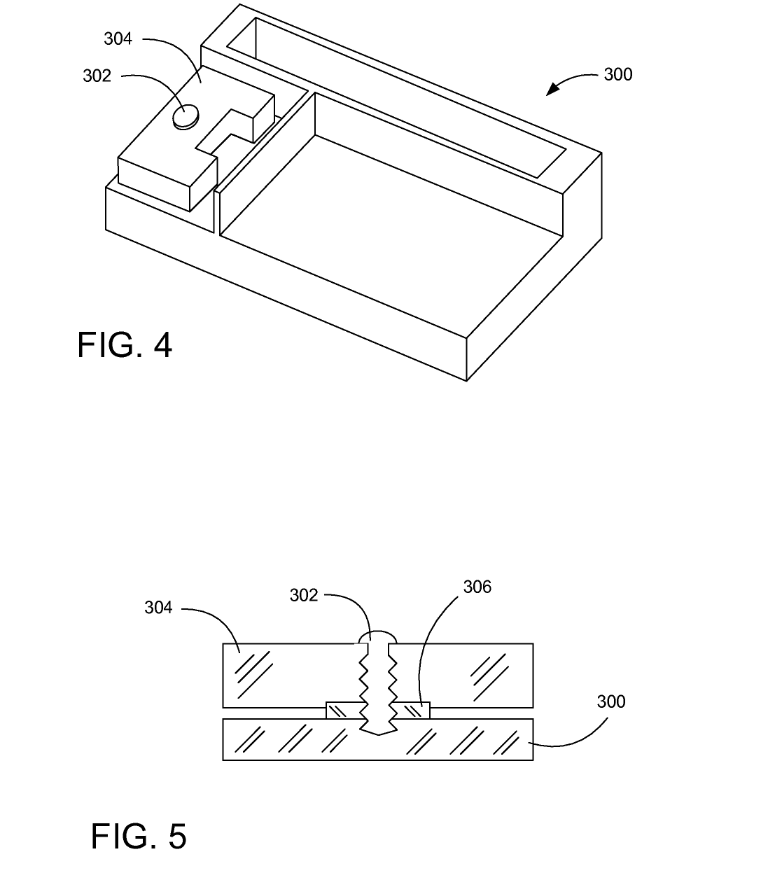

FIG. 4 is an isometric view of a drive carrier 300 having a damping material 302, and inertia weight 304. The inertia weight 304 can be suitably shaped, for example, to fit available space on the drive carrier 300 or to alter the carrier's center of mass. FIG. 5 is a cross-sectional view of the carrier 300, damping material 302, inertia weight 304, and spacer 306. The damping material 302 couples the inertia weight 304 with the drive carrier 300 such that damping material 302 is subjected to shear during vibration, thereby mitigating the vibration. The spacer 306 is positioned such that the inertia weight 304 is isolated from the drive carrier 300.

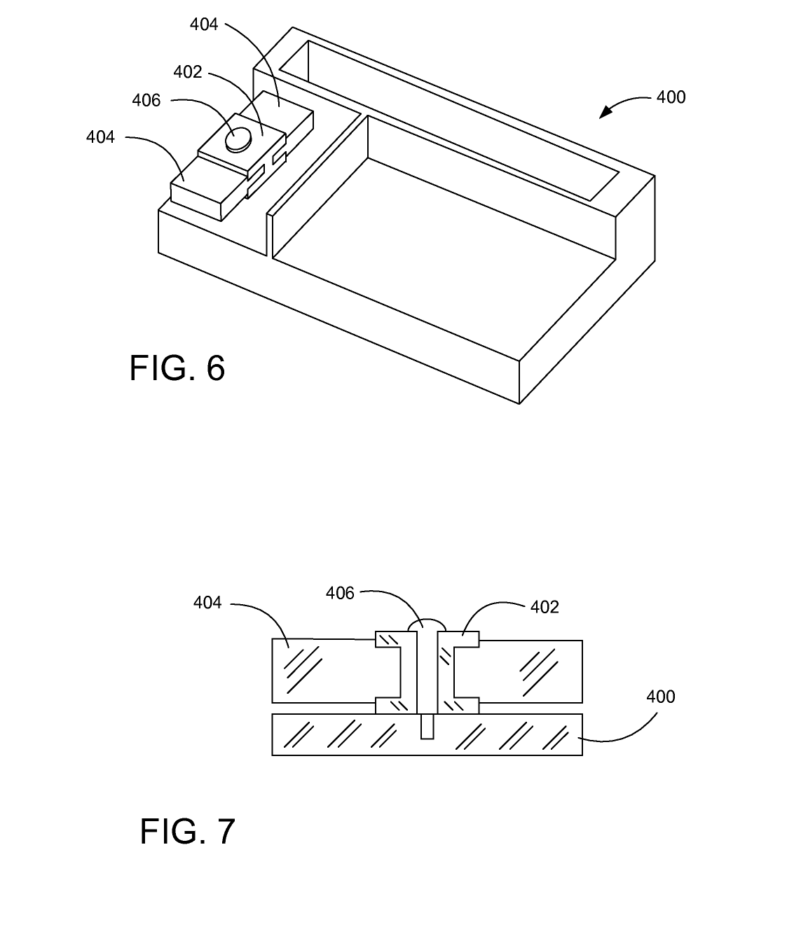

FIG. 6 is an isometric view of a drive carrier 400 having a damping material 402, a plurality of inertia weights 404, and fastener 406. The inertia weights 404 can be suitably shaped, for example, to fit into the shaped damping material 402. FIG. 7 is a cross-sectional view of the carrier 400, damping material 402, inertia weight 404, and fastener 406. The damping material 402 is positioned such that the inertia weights 404 are isolated so that the damping material 402 is subjected to shear during vibration and the inertia weights 404 do not directly contact the carrier 400. The fastener 406, shown as a shoulder bolt, attaches the damping material 402 to the drive carrier 400.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. An apparatus comprising:
a drive carrier,
a damping material connected to the drive carrier, and
an inertia weight connected to the damping material and isolated from the drive carrier.

2. The apparatus of claim 1, wherein the damping material is positioned such that the damping material is subjected to shear during vibration.

3. The apparatus of claim 2, wherein the damping material and the inertia weight are positioned at a location of the drive carrier to mitigate linear and rotational vibration.

4. The apparatus of claim 2, wherein the damping material is adhered to the carrier and to the inertia weight.

5. The apparatus of claim 2, wherein the damping material is positioned on a top side of the carrier.

6. The apparatus of claim 2, wherein the damping material is viscoelastic.

7. The apparatus of claim 1, wherein the damping material and inertia weight form a spring-mass-damper system.

8. The apparatus of claim 1, further comprising a plurality of inertia weights.

9. The apparatus of claim 1, wherein the damping material is positioned such that the inertia weight does not directly contact the drive carrier.

10. The apparatus of claim 1, wherein the drive carrier is configured to receive one of a solid state drive or disc drive.

11. A method comprising:
attaching a damping material to a drive carrier; and
attaching a mass to the damping material such that the mass is isolated from the drive carrier.

12. The method of claim 11, further comprising:
positioning the damping material such that the damping material is subjected to shear during vibration.

13. The method of claim 12, further comprising:
inserting a disc drive into the drive carrier.

14. The method of claim 12, further comprising:
inserting a solid state drive into the drive carrier.

15. The method of claim 11, further comprising:
attaching a plurality of damping material sections; and
attaching a mass to each damping material section.

16. An apparatus comprising:
a first inertia weight attached to a drive carrier; and
a damping material sandwiched between the first inertia weight and a second inertia weight.

17. The apparatus of claim 16, wherein the damping material is positioned to be subjected to shear during linear and rotational vibration.

18. The apparatus of claim 17, further comprising:
a plurality of damping material sections.

19. The apparatus of claim 16, wherein the drive carrier encloses the first inertia weight, second inertia weight, and damping material.

20. The apparatus of claim 16, wherein the drive carrier is configured to receive a storage device.
